(19) United States
(12) Patent Application Publication
(10) Pub. No.: US 2026/0019134 A1
(43) Pub. Date: Jan. 15, 2026

(54) METHOD FOR BEAM INDICATION FRAMEWORK FOR L1/L2 CENTRIC INTER-CELL MOBILITY

(71) Applicant: Google LLC, Mountain View, CA (US)

(72) Inventors: Yushu Zhang, Beijing (CN); Chih-Hsiang Wu, Taipei City (TW)

(21) Appl. No.: 18/992,899

(22) PCT Filed: Aug. 5, 2022
(86) PCT No.: PCT/CN2022/110603

§ 371 Date: Jan. 9, 2025

(51) Int. Cl. H04B 7/06; H04L 5/00; H04W 76/16

(52) U.S. Cl. CPC H04B 7/0695; H04L 5/0051; H04W 76/16

(57) ABSTRACT

This disclosure provides systems, devices, apparatus, and methods, including computer programs encoded on storage media, for beam indication techniques for ICM. A UE (102) receives (310), from a first network entity (304), an indication of a beam associated with a second network entity (305). The indication of the beam corresponds to at least one of a TCI state associated with non-dedicated signaling from the second network entity (305) or an activation delay time for the beam based on whether the beam corresponds to dedicated signaling from the second network entity (305) to the UE (102) or the non-dedicated signaling from the second network entity (305). The UE (102) attempts to receive a downlink communication from the second network entity (305) based on the indication.

### TECHNICAL FIELD

The present disclosure relates generally to wireless communication, and more particularly, to beam indication techniques for inter-cell mobility (ICM).

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity over other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies that support communication with multiple UEs. As mobile broadband technologies evolve, improvements in mobile broadband have been useful to continue the progression of such technologies. For example, a serving cell base station may perform an inter-cell beam management (ICBM) procedure to indicate, to the UE, a transmission configuration indicator (TCI) state associated with a UE-dedicated downlink reference signal of a neighbor cell base station. However, the ICBM procedure does not address non-UE-dedicated signaling from a neighbor cell base station.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

For dedicated signaling from a base station to a user equipment (UE), the base station indicates a transmission configuration indicator (TCI) state associated with a downlink reference signal of a serving cell or a TCI state associated with a downlink reference signal of a neighbor cell/target cell. However, for non-dedicated signaling from the base station to the UE, the base station indicates a TCI state associated with the downlink reference signal of the serving cell, but not the downlink reference signal of the neighbor cell/target cell. A lack of TCI state for non-dedicated signaling from a neighbor/target cell might hinder the serving cell from being changed to the neighbor cell/target cell to support inter-cell mobility (ICM) procedures.

Additionally, the base station may transmit a radio resource control (RRC) configuration to the UE for pre-configuring the UE to communicate with the neighbor cell/target cell. The pre-configuration may include RRC parameters associated with the neighbor cell/target cell. After the base station/serving cell transmits the beam indication signaling to the UE based on the TCI state associated with the neighbor cell/target cell, the UE applies the RRC parameters to communicate with the neighbor cell/target cell according to the pre-configuration.

Increased complexities associated with updating the RRC parameters might result in a common beam activation delay used for non-ICM procedures being unsuitable for ICM procedures. For instance, the base station and the UE could perform the non-ICM procedures based on a shorter beam activation delay than the ICM procedures. Hence, the length of the beam activation delay may depend upon whether the base station and the UE are implementing the ICM procedures or the non-ICM procedures. Furthermore, Layer 1 (L1) signaling used for acknowledgment/negative acknowledgment (ACK/NACK) feedback for beam indication operations might cause NACK-to-ACK or ACK-to-NACK errors in ICM procedures. The UE may attempt to recover from the errors when such errors occur.

Aspects of the present disclosure address the above-noted and other deficiencies by improving beam indication and communication procedures associated with ICM. According to some aspects, the apparatus (e.g., a UE) receives, from a first network entity, an indication of a beam associated with a second network entity. The indication of the beam corresponds to at least one of: (1) a TCI state associated with non-dedicated signaling from the second network entity or (2) an activation delay time for the beam based on whether the beam corresponds to dedicated signaling from the second network entity to a UE or the non-dedicated signaling from the second network entity. The UE attempts to receive a downlink communication from the second network entity based on the indication.

According to some aspects, the apparatus (e.g., a first network entity) transmits, to a UE, an indication of a beam associated with a second network entity. The indication of the beam corresponds to at least one of: (1) a TCI state associated with non-dedicated signaling from the second network entity or (2) an activation delay time for the beam based on whether the beam corresponds to dedicated signaling from the second network entity to the UE or the non-dedicated signaling from the second network entity. The first network entity receives ACK/NACK feedback for the indication transmitted to the UE.

According to some aspects, the apparatus (e.g., a second network entity) receives a backhaul communication from a first network entity indicative of a first transmission from the first network entity including an indication of a beam associated with a second network entity. The indication of the beam corresponds to at least one of: (1) a TCI state associated with non-dedicated signaling from the second network entity or (2) an activation delay time for the beam based on whether the beam corresponds to dedicated signaling from the second network entity to a UE or the non-dedicated signaling from the second network entity. The second network entity attempts to transmit a downlink communication using the non-dedicated signaling based on the backhaul communication received from the first network entity indicative of the first transmission from the first network entity including the indication of the beam associated with the second network entity.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system associated with a plurality of cells.

FIG. 2 illustrates a timing diagram of a transmission configuration indicator (TCI) update procedure based on TCI signaling between a user equipment (UE) and a base station or an entity at a base station.

FIG. 3 is a communication signaling diagram that supports a separate delay for inter-cell mobility (ICM) signaling.

FIG. 4 is a communication signaling diagram for dual connectivity situations, such as for network entities with quasi co-located (QCLed) antenna ports.

FIG. 5 illustrates a primary cell (PCell) indication diagram based on beam indication signaling associated with ICM.

FIG. 6 is a communication signaling diagram when the UE performs a timer-based fallback operation to the first network entity based on a layer 1/layer 2 (L1/L2) ICM failure.

FIG. 7 is a communication signaling diagram supporting source and target cells conducting a successful handover using beam indication techniques for ICM.

FIGS. 8A-8B are a flowchart of a method of wireless communication at a UE.

FIG. 9 is a flowchart of a method of wireless communication at a first network entity.

FIG. 10 is a flowchart of a method of wireless communication at a second network entity.

FIG. 11 is a diagram illustrating an example of a hardware implementation for an example UE apparatus.

FIG. 12 is a diagram illustrating an example of a hardware implementation for an example network entity.

### DETAILED DESCRIPTION

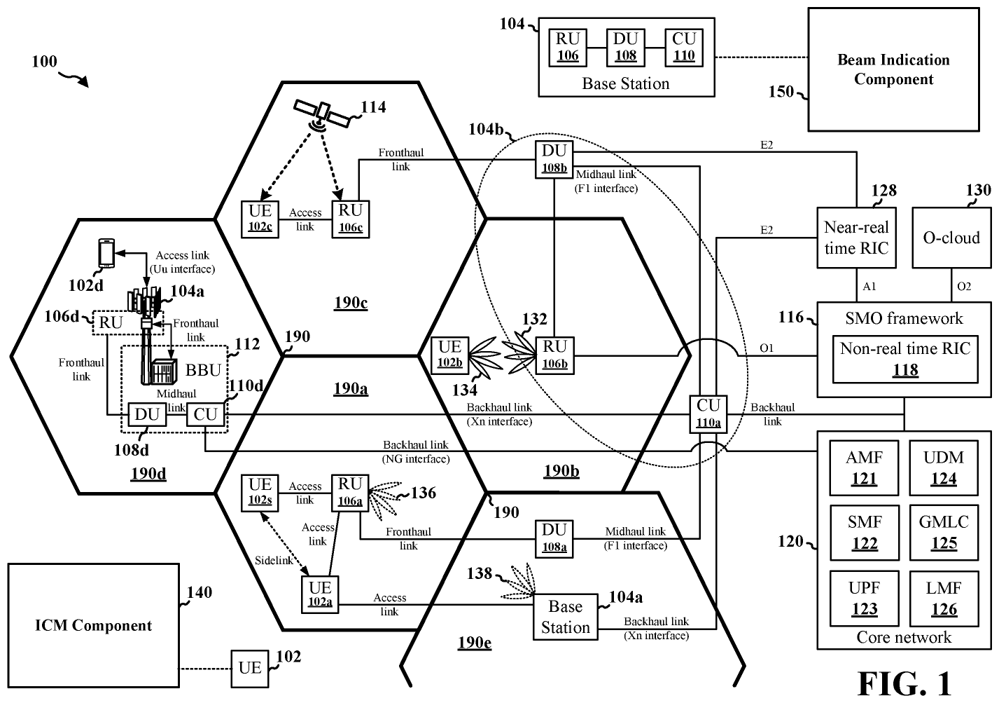

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links based on F1 interfaces. The DUs 108a-108b may respectively communicate with the RU 106a and the RUs 106b-106c via respective fronthaul links. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link. For example, the CU 110d communicates with the core network 120 over a backhaul link based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link based on an Xn interface. For example, the CU 110d of the base station 104a communicates with the CU 110a of the base station 104b over the backhaul link based on the Xn interface. Similarly, the base station 104a of the cell 190e may communicate with the CU 110a of the base station 104b over a backhaul link based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link between the RU 106d and the baseband unit (BBU) 112 of the cell 190d or, more specifically, the fronthaul link between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (IFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FRI is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FRI and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 109e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include an inter-cell mobility (ICM) component 140 configured to receive, from a serving base station entity such as RU 106b, an indication of a beam associated with a neighbor base station entity such as base station 104a, the indication of the beam corresponding to at least one of a transmission configuration indicator (TCI) state associated with non-dedicated signaling from the neighbor base station entity (e.g., base station 104a) or an activation delay time for the beam based on whether the beam corresponds to dedicated signaling from the neighbor base station entity (e.g., base station 104a) to the UE 102 or the non-dedicated signaling from the neighbor base station entity (e.g., base station 104a); and attempt to receive a downlink communication from the neighbor base station entity (e.g., base station 104a) based on the indication.

In certain aspects, the base station 104 or an entity of the base station 104 may include a beam indication component 150 configured to: transmit, to a UE 102, an indication of a beam associated with a neighbor base station entity such as base station 104a, the indication of the beam corresponding to at least one of a TCI state associated with non-dedicated signaling from the neighbor base station entity (e.g., base station 104a) or an activation delay time for the beam based on whether the beam corresponds to dedicated signaling from the neighbor base station entity (e.g., base station 104a) to the UE 102 or the non-dedicated signaling from the neighbor base station entity (e.g., base station 104a); and receive acknowledgment/negative acknowledgment (ACK/NACK) feedback for the indication transmitted to the UE 102. In further aspects, the beam indication component 150 is configured to: receive a backhaul communication from a serving base station entity such as RU 106b indicative of a first transmission from the serving base station entity (e.g., RU 106b) including an indication of a beam associated with the neighbor base station entity (e.g., base station 104a), the indication of the beam corresponding to at least one of a TCI state associated with non-dedicated signaling from the neighbor base station entity (e.g., base station 104a) or an activation delay time for the beam based on whether the beam corresponds to dedicated signaling from the neighbor base station entity (e.g., base station 104a) to a UE 102 or the non-dedicated signaling from the neighbor base station entity (e.g., base station 104a); and attempt to transmit a downlink communication using the non-dedicated signaling based on the backhaul communication received from the serving base station entity (e.g., RU 106b) indicative of the first transmission from the serving base station entity (e.g., RU 106b) including the indication of the beam associated with the neighbor base station entity (e.g., base station 104a). Although the following description may be focused on 5G NR, the concepts described herein may be applicable to other similar areas, such as 5G-Advanced and future versions, LTE, LTE-advanced (LTE-A), and other wireless technologies.

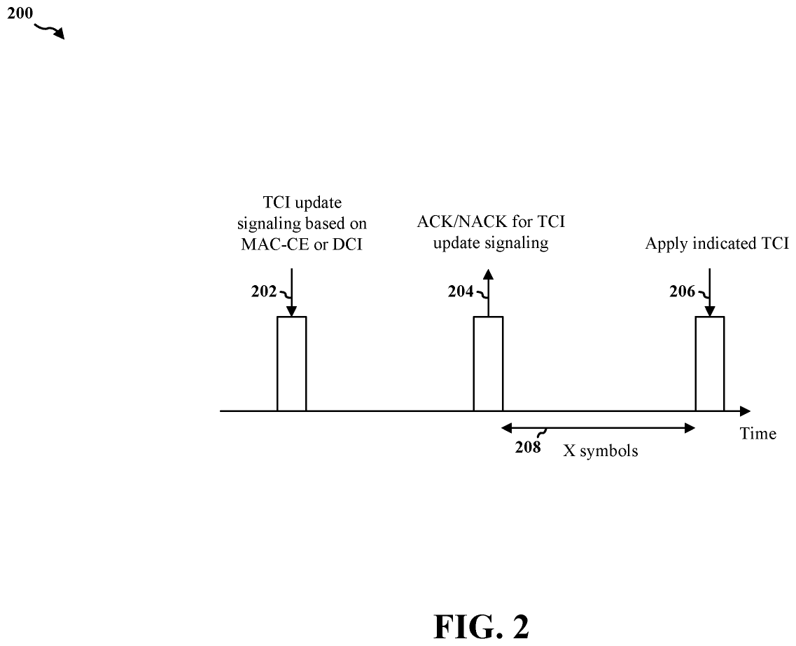

FIG. 2 illustrates a diagram 200 of a TCI update procedure based on TCI signaling between a UE and a base station or an entity at a base station. A cell radius/coverage area of the base station might be based on a link budget. The “link budget” refers to an accumulation of total gains and losses in a system, which provide a received signal level at a receiver, such as the UE. The receiver may compare the received signal level to a receiver sensitivity to determine whether a channel provides at least a minimum signal strength for signals communicated between the receiver and a transmitter (e.g., the UE and the base station).

In order to increase the link budget, the base station and the UE might perform an analog beamforming operation to activate a beam pair associated with an increased signal strength. Both the base station and the UE maintain a plurality of beams that may be used for the beam pair. A beam pair that decreases a coupling loss might result in an increased coverage gain for the base station and the UE. “Coupling loss” refers to a path loss/reduction in power density between a first antenna of the base station and a second antenna of the UE, and may be indicated in units of decibel (dB). Beam selection procedures for the beam pair activated by the base station and the UE might be associated with one or more of beam measurement operations, beam measurement reporting, or beam indication procedures.

The base station may indicate 202 a TCI state to the UE via downlink signaling. For example, the base station indicates 202 TCI updating signaling based on a medium access control-control element (MAC-CE) or downlink control information (DCI). “TCI state” refers to a set of parameters for configuring a quasi co-location (QCL) relationship between one or more downlink reference signals and corresponding antenna ports. For example, the TCI state can be indicative of a QCL relationship between downlink reference signals in a channel state information-reference signal (CSI-RS) set and physical downlink shared channel (PDSCH) demodulation reference signal (DMRS) ports. Due to the theorem of antenna reciprocity, a single TCI state might provide beam indications for both downlink channels/signals and uplink channels/signals.

Beam indication techniques based on TCI signaling may include joint beam indication or separate beam indications. “Joint beam indication” refers to a single/joint TCI state that is used to update the beams for both the downlink channels/signals and the uplink channels/signals. For example, the base station can indicate a single/joint TCI state in downlink TCI signaling that is configured based on a DLorJointTCIState parameter to update the beams for both the downlink channels/signals and the uplink channels/signals. For TCI signaling based on the joint TCI state, the base station may transmit a synchronization signal block (SSB) or a CSI-RS to indicate the QCL relationship between the downlink channels/signals and a spatial relation of the uplink channels/signals. In a first aspect, the transmitted 202 TCI update signaling may correspond to a joint beam indication for both the downlink channels/signals and the uplink channels/signals.

“Separate beam indications” refers to a first TCI state that is used to update a first beam for the downlink channels/signals and a second TCI state that is used to update a second beam for the uplink channels/signals. For example, the base station can indicate the first TCI state in the downlink TCI signaling configured based on the DLorJointTCIState parameter to update the first beam for the downlink channels/signals, and may indicate the second TCI state in further downlink TCI signaling configured based on an UL-TCIState parameter to update the second beam for the uplink channels/signals. If the base station indicates the second TCI state (e.g., uplink TCI) in a downlink reference signal, the downlink reference signal may correspond to the SSB, the CSI-RS, etc. In examples where an uplink reference signal is used to indicate the second TCI state, the uplink reference signal may correspond to a sounding reference signal (SRS), which might indicate the spatial relation of the uplink channels/signals. In a second aspect, the TCI update signaling transmitted 202 may correspond to either the downlink channels/signals or the uplink channels/signals based on the separate beam indications technique.

The base station may configure a QCL type and/or a source reference signal for the QCL signaling. QCL types for downlink reference signals might be based on a higher layer parameter, such a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter. The UE may use a same spatial transmission filter to indicate the spatial relation as used to receive the downlink reference signal from the base station or transmit the uplink TCI signaling. The transmitted 202 TCI update signaling updates the TCI state for the channels of a CC that share the TCI state indicted based on the TCI update signaling. The CC might be associated with a cell included in a cell list. The cell list is configured based on RRC signaling indicative of parameters such as a simultaneousTCI-UpdateList1 parameter, a simultaneousTCI-UpdateList2 parameter, a simultaneousTC1-Update List3 parameter, or a simultaneousTCI-UpdateList4 parameter.

The UE transmits 204 ACK/NACK feedback to the base station responsive to the TCI update signaling transmitted 202 from the base station to the UE. The TCI state indicated via the TCI update signaling might be applied 206 by the UE at least X symbols 208 after the UE transmits 204 the ACK/NACK feedback to the base station. For example, if the UE transmits 204 an ACK to the base station in response to the TCI update signaling, the UE applies 206 the indicated TCI state after the configured duration 208. In examples where the UE transmits 204 a NACK to the base station in response to the TCI update signaling, the UE does not apply 206 the TCI state indicated via the TCI update signaling transmitted 202 from the base station to the UE. A duration of the X symbols 208 before the UE applies 206 the indicated TCI state might be configured based on RRC signaling from the base station.

Signaling communicated between the base station and the UE may be dedicated signaling or non-dedicated signaling. “Dedicated signaling” refers to signaling between the base station and the UE that is UE-specific. For example, dedicated signaling correspond to a physical downlink control channel (PDCCH), a PDSCH, a physical uplink control channel (PUCCH), or a physical uplink shared channel (PUSCH) associated with the cell list that shares the indicated TCI state. “Non-dedicated signaling” refers to signaling between the base station and a non-specific UE. For example, non-dedicated signaling corresponds to physical broadcast channel (PBCH), PDCCH/PDSCH transmitted from the base station for non-specific UEs, aperiodic CSI-RS, or SRS for codebook, non-codebook, or antenna switching.

For dedicated signaling from the base station to the UE, the base station transmits 202 the TCI state associated with a first downlink reference signal of a serving cell and/or the TCI state associated with a second downlink reference signal of a neighbor cell/target cell. However, for non-dedicated signaling from the base station to the UE, the base station transmits 202 the TCI state associated with the first downlink reference signal of the serving cell, but not the second downlink reference signal of the neighbor cell/target cell. A lack of TCI state information for non-dedicated signaling from the neighbor cell/target cell might hinder the serving cell from being changed to the neighbor cell/target cell to support ICM procedures.

PDCCH in a control resource set (CORESET) associated with Types 0/0A/0B/1/2 common search spaces, and PDSCH scheduled by such PDCCH are non-dedicated signals. However, other PDCCH and PDSCH signaling may be dedicated signals. The search space type might be defined based on standardized protocols. PUSCH/PUCCH triggered at the UE by the DCI, activated based on the MAC-CE, or configured based on an uplink grant in RRC signaling from the base station are dedicated signals.

ICM procedures may include the base station transmitting 202 a TCI state associated with a downlink reference signal (e.g. SSB, CSI-RS, etc.) of a neighbor cell/target cell, where the downlink reference signal corresponds to dedicated signaling. For the non-dedicated signaling, the TCI state transmitted 202 might be associated with the serving cell. Thus, the serving cell is not changed for the UE after beam indication operations. Such procedures may be referred to as inter-cell beam management (ICBM) procedures.

Whether non-dedicated signaling (e.g., non-dedicated PDCCH/PDSCH, aperiodic CSI-RS, and/or SRS) shares the indicated TCI state might be based on an RRC configuration associated with RRC signaling. Other channels/signals might not share the indicated TCI state. The base station might transmit separate TCI signaling for the other channels/signals that do not share the indicated TCI state. For example, the base station can transmit the separate TCI signaling via MAC-CE. Signaling that does not share the indicated TCI state might include periodic or semi-persistent CSI-RS, the SSB, a PRACH, or an SRS for beam management.

The serving cell/base station transmits an RRC configuration to the UE for pre-configuring the UE to communicate with the neighbor cell/target cell. The pre-configuration includes RRC parameters associated with the neighbor cell/target cell. The RRC parameters might be included in an RRCReconfiguration message. After the serving cell/base station transmits the beam indication signaling to the UE based on the TCI state associated with the neighbor cell/target cell, the UE applies the RRC parameters to communicate with the neighbor cell/target cell according to the pre-configuration. Under certain circumstances related to handover, the serving cell is updated to the neighbor cell/target cell after the beam indication operations.

Increased complexities associated with the UE updating the RRC parameters might result in a common beam activation delay used for non-ICM procedures being unsuitable for ICM procedures. For instance, the base station and the UE could perform the non-ICM procedures based on a shorter beam activation delay than the ICM procedures. Hence, the length of the beam activation delay may depend upon whether the base station and the UE are implementing the ICM procedures or the non-ICM procedures. Furthermore, Layer 1 (L1) signaling used for ACK/NACK feedback for beam indication operations might cause NACK-to-ACK or ACK-to-NACK errors in ICM procedures. The UE may attempt to recover from the errors when such errors occur. In addition, some channels or CCs might not share the transmitted 202 indicated TCI state based on the TCI update signaling. For example, some channels or CCs are associated with the neighbor cell/target cell, while other channels or CCs are associated with the serving cell. A neighbor cell/target cell could have a physical cell identifier (ID) that is different from a cell ID of the serving cell.

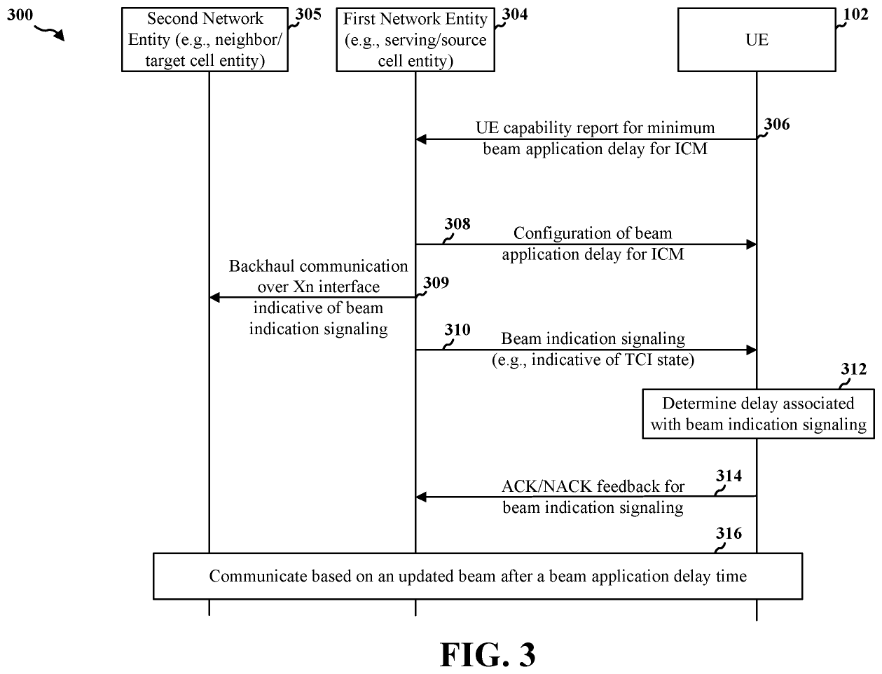

FIG. 3 is a communication signaling diagram 300 illustrating communications between the UE 102 and the first/second network entities 304-305. The first/second network entities 304-305 may correspond to different base stations 104 or entities at the different base stations 104, such as the RUs 106, the DUs 108, the CUS 110, etc. In one example, the first network entity 304 provides a serving cell to the UE (e.g., RU 106b provides a serving cell 190b to the UE 102b) and the second network entity 305 provides a neighbor cell (e.g., RU 106a provides neighbor cell 190a to the UE 102b). The first network entity 304 and the UE 102 may perform a beam indication technique based on a configuration of a first beam application delay for non-ICM procedures or a second beam application delay for ICM procedures.

As the UE 102 might update the RRC parameters for ICM procedures, the first beam application time for the ICM procedure might be different than the second beam application time for the non-ICM procedures, such as ICBM, which might be configured based on RRC signaling (e.g., associated with a beamAppTime parameter). The second beam application time for the ICM procedure might be longer than the first beam application time for the non-ICM/ICBM procedure based on the time utilized by the UE 102 to update the RRC parameters for the ICM procedure. A value of the beamAppTime parameter may correspond to {1, 2, 4, 7, 14, 28, 42, 56, 70, 84, 224, 336} symbols, where values greater than 70 might not be applicable to frequency range 1 (FR1).

Accordingly, the first beam application delay might be implemented to update the TCI state for the non-ICM procedures, such as ICBM, and the second beam application delay (e.g., longer delay) might be implemented to update the TCI state for the ICM procedures. The UE 102 transmits 306 a UE capability report to the first network entity 304. The UE capability report is indicative of a minimum beam application delay for the ICM procedures. That is, the UE capability report transmitted 306 by the UE 102 might indicate the second/longer beam application delay utilized by the UE 102 to update the RRC parameters for the ICM procedures.

The first network entity 304 transmits 308 a configuration to the UE 102 of the second beam application delay for the ICM procedures. The configuration transmitted 308 by the first network entity 304 might be based on the UE capability report received 306 from the UE 102. In examples, the first network entity 304 may utilize RRC signaling to indicate the configuration of the second beam application delay to the UE 102 for the ICM procedures. A beamAppTimeForMobility parameter may be indicated by the first network entity 304 in the RRC signaling to the UE 102 in association with a pdsch-config parameter, or the beamAppTime ForMobility parameter may be indicated by the first network entity 304 based on the MAC-CE or the DCI (e.g., in beam indication signaling 310) based on the UE capability received 306 from the UE 102. The second beam application delay for the ICM procedure may be configured per neighbor cell/target cell, or may be configured commonly across the neighbor cells/target cells. Next, the first network entity 304 transmits 309 a backhaul communication over an Xn interface to the second network entity 305, where the backhaul communication is indicative of beam indication signaling that the first network entity 304 intends to transmit to the UE 102.

Afterwards, the first network entity 304 transmits 310 the beam indication signaling to the UE 102. The beam indication signaling indicates an updated beam to be used for communicating with the UE 102. For example, the updated beam can correspond to a first updated beam of the first network entity 304 (e.g., non-ICM procedure) or a second updated beam of the second network entity 305 (e.g., ICM procedure). Then, the UE 102 determines 312 the delay associated with the beam indication signaling. That is, the UE 102 determines whether the received 310 beam indication signaling is associated with the ICM procedure or the non-ICM procedure. Whether the UE 102 applies the first beam application delay for the non-ICM procedures, such as ICBM, or the second beam application delay for the ICM procedures may be determined 312 based on an indicated TCI state associated with the received 310 beam indication signaling received. If the TCI state associated with the received 310 beam indication signaling from the first network entity 304 is indicative of the ICM procedures (e.g. RRC parameter update), the UE 102 determines 312 that the delay corresponds to the second beam application delay for the ICM procedures. Otherwise, the UE 102 determines 312 that the delay corresponds to the first beam application delay for the non-ICM procedures, such as ICBM. A duration of the beam application delay could be an enumerated binary indicator (e.g., 00=10 ms, 01=25 ms, 10=50 ms, 11=100 ms, or 00=56 symbols, 01=112 symbols, 10=224 symbols, 11=448 symbols) or a direct number (integer value: 10-100 ms, or 10-100 slots).

In further examples, the first network entity 304 may configure the UE 102 to apply the first beam application delay for the non-ICM procedures or the second beam application delay for the ICM procedures based on the beam indication signaling transmitted 310 to the UE 102. For beam indication signaling based on MAC-CE, a flag may be included for each indicated TCI or TCI code-point or per MAC-CE to indicate whether the updated beam to be used for communicating with the UE 102 is for the ICM procedures or the non-ICM/ICBM procedures.

For beam indication signaling based on DCI, a beam indication field may be included in the DCI to indicate whether the updated beam to be used for communicating with the UE 102 is for the ICM procedures or the non-ICM/ICBM procedures. In some examples, a legacy field included in the DCI, such as fields indicative of an antenna port, a serving cell index, or a bandwidth part (BWP) index, may also be used for the beam indication field to indicate whether the updated beam is for the ICM procedures or the non-ICM/ICBM procedures. In still further examples, a starting control channel element (CCE) index for the PDCCH with the DCI may be used to indicate whether the updated beam is for the ICM procedures or the non-ICM/ICBM procedures. An odd-numbered starting CCE index might be indicative of the ICM procedures and an even-numbered starting CCE index might be indicative of the non-ICM/ICBM procedures. In yet further examples, whether the beam indication is for the ICM procedures or the non-ICM/ICBM procedures might be based on a search space (SS) or a CORESET used for the PDCCH. Some SSs or CORESETs may be predefined or configured for beam indication associated with the ICM procedures, while other SSs/CORESETs may be predefined or configured for beam indication associated with the non-ICM/ICBM procedures.

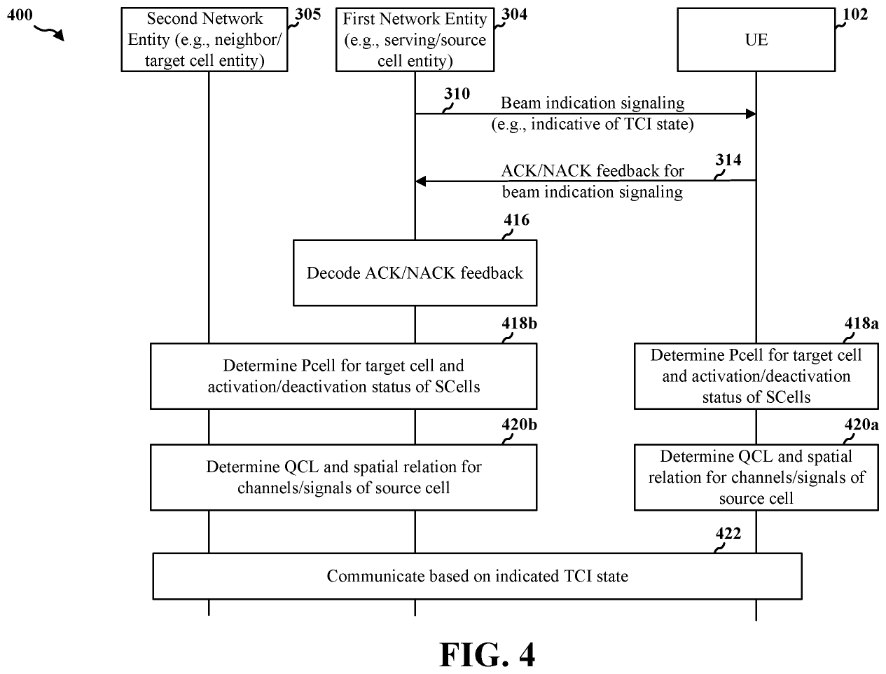

After the UE 102 receives 310 the beam indication signaling from the first network entity 304 and determines 312 the delay associated with the beam indication signaling, the UE 102 might transmit 314 ACK/NACK feedback for the beam indication signaling. For example, if the UE 102 transmits an ACK to the first network entity 304 in response to receiving 310 the beam indication signaling, the first network entity 304 refrains from further communications with the UE 102 in view of the ICM procedures. If the UE 102 transmits a NACK to the first network entity 304 in response to receiving 310 the beam indication signaling, the first network entity 304 might determine to retransmit the beam indication signaling transmitted 310 to the UE 102. After transmitting 314 the ACK to the first network entity 304 for the beam indication signaling, the UE 102 applies the indicated beam based on the determined 312 delay time. The UE 102 and the first network entity 304 may count the beam application delay from a last symbol of the ACK transmitted 314 in response to the beam indication signaling. Alternatively, the UE 102 and the first network entity 304 may count the beam application delay from a last symbol of the beam indication signaling transmitted 310 from the first network entity 304 to the UE 102. Afterwards, the UE 102 communicates 316 with the first/second network entities 304-305 based on an updated beam after a beam application delay time. FIG. 3 supports a separate delay for ICM signaling (e.g., different from ICBM delay). FIG. 4 builds upon FIG. 3 for dual connectivity situations, especially for network entities with QCLed antenna ports.

FIG. 4 is a communication signaling diagram 400 illustrating communications between the UE 102 and the first/second network entities 304-305. The transmitted 310 and received 314 signaling in FIG. 4 correspond to FIG. 3 elements 310, 314 but specifically for source and target base station entities rather than simply serving and neighbor cells. The beam indication signaling transmitted 310 from the first network entity 304 (e.g., source cell) is indicative of a TCI state associated with the second network entity 305 (e.g., target cell). After receiving 314 ACK/NACK feedback signal from the UE 102, the first network entity 304 decodes 416 the ACK/NACK feedback signal received from the UE 102. For example, if the serving cell first network entity 304 receives an ACK in response to transmission 310 of the beam indication signaling, the first network entity 304 might update communication procedures based on the indicated beam. If the serving cell first network entity 304 instead receives a NACK, the first network entity 304 might determine to retransmit to the UE 102 the beam indication signaling previously transmitted 310.

The UE 102 may be configured for carrier aggregation when the beam indication signaling is received 310 from the first network entity 304. If the beam indication signaling is indicative of a TCI state associated with the second network entity 305 (e.g., target cell) that triggers RRC reconfiguration, the UE 102 determines 418a which serving cell in a cell list corresponds to the PCell for the target cell as well as an activation/deactivation status of corresponding SCells. The first/second network entities 304-305 may perform a similar determination 418b of the PCell for the target cell and the activation/deactivation status of the corresponding SCells based on the association between the indicated TCI state and the first/second network entities 304-305. In examples, the first network entity 304 transmits control signaling (not shown) to the UE 102 after 310 to indicate the PCell and active SCells to the UE 102, so that the UE 102 and the network entities 304-305 make the same determinations 418a-418b and 420a-420b. For instance, the first network entity 304 may configure the cell list to the UE 102 based on RRC signaling. The RRC signaling can be associated with a simultaneousTCI-UpdateList1 parameter, a simultaneousTCI-Update List2 parameter, a simultaneousTCI-UpdateList3 parameter, or a simultaneousTCI-UpdateList4 parameter. In further examples, the control signaling may be transmitted 310 to the UE 102 together with the beam indication signaling.

The UE 102 and the network entities 304-305 determine 420a-420b a QCL and a spatial relation for channels/signals of the source cell. In examples, some communications might occur over channels that do not share the indicated TCI state associated with the beam indication signaling, but may still be configured with a TCI state that is associated with the serving cell. The UE communicates 422 with the first/second network entities 304-305 based on the indicated TCI state.

After the beam application time associated with the TCI state indicative of the target cell for the ICM procedure, the UE 102 and the first/second network entities 304-305 might determine that the PCell for the target cell is the cell associated with the beam indication signaling or the ACK for the beam indication signaling. In an example, the UE 102 and the first/second network entities 304-305 determine that the PCell for the target cell is within the coverage of the PCell for the source cell. In further examples, the first network entity 304 may configure the PCell for the target cell based on higher layer signaling, such as RRC signaling, a MAC-CE for beam indication, or DCI associated with the beam indication signaling. For example, the PCell for the target cell corresponds to a CC indicated based on a serving cell index in the DCI associated with the beam indication signaling.

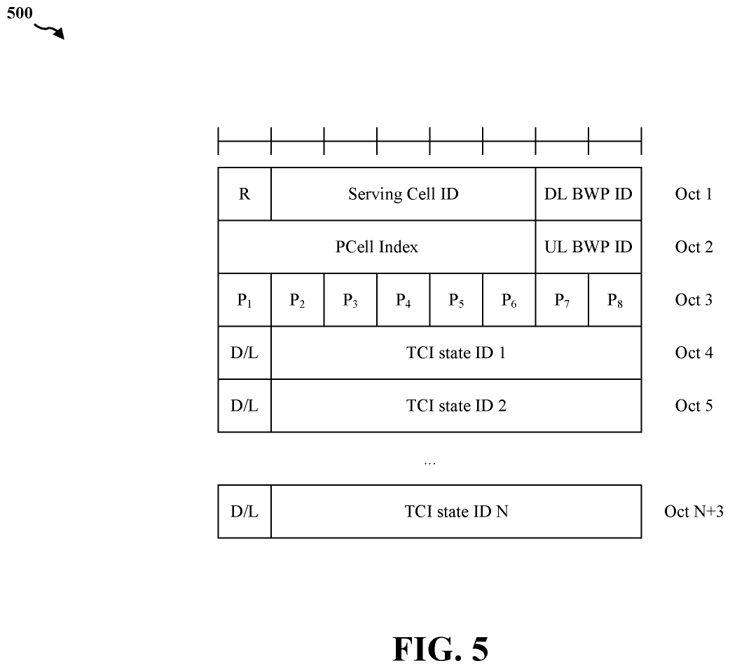

RRC signaling indicative of the RRC configuration parameters for the target cell might be indicative of the PCell. The RRC configuration parameters may be indicated in an RRCReconfiguration message. In examples where TCI signaling is indicated based on the MAC-CE, the first network entity 304 may indicate a PCell index for the cell list to indicate that the target cell is the PCell. FIG. 5 illustrates a PCell indication diagram 500 based on beam indication signaling associated with ICM. For example, the PCell indication diagram 500 is indicative of a MAC-CE format, where the field “PCell index” is used to indicate a particular cell within the cell list as the PCell. The PCell indication diagram 500 may also be applicable to primary secondary cell (PSCell) indications, or alternatively, to ICM procedures that are not based on dual connectivity operations.

After the beam application time for the TCI associated with the target cell for the ICM procedure, the UE 102 and the first/second network entities 304-305 may determine that CCs other than the PCell or the PSCell for the target cell are deactivated. That is, the UE 102 and the first/second network entities 304-305 may determine that the SCells for the target cell are deactivated. Alternatively, the UE 102 and the first/second network entities 304-305 may determine that at least a subset of CCs other than the CCs for the PCell or the PSCell (i.e., the CCs for the SCells) for the target cell are activated. One or more active CC indexes may be configured based on higher layer signaling, such as RRC signaling or MAC-CE.

The UE 102 may also refrain from monitoring at least a subset of the channels/signals in an active CC having a TCI state or QCL relationship associated with a cell other than the target cell after the beam application time for the TCI associated with the target cell for the ICM procedure. In examples, the UE 102 may refrain from monitoring non-dedicated channels/signals in the active CC having the TCI state or QCL relationship associated with the cell other than the target cell. The UE 102 may continue to monitor the dedicated channels/signals, even if the TCI state and QCL relationship is associated with a different cell.

PDCCH in a CORESET associated with Type 0/0A/0B/1/2 common search spaces, and PDSCH scheduled based on the PDCCH in the CORESET are non-dedicated signals. Other signals, such as periodic/semi-persistent CSI-RS and SRS for beam management are dedicated signals. For rate matching, the UE 102 and the first/second network entities 304-305 may determine that the resource elements (REs) used for the channels/signals that the UE 102 does not monitor are available resources. In an alternative example, the UE 102 and the first/second network entities 304-305 may determine that the REs used for the channels/signals that the UE 102 does not monitor are unavailable resources.

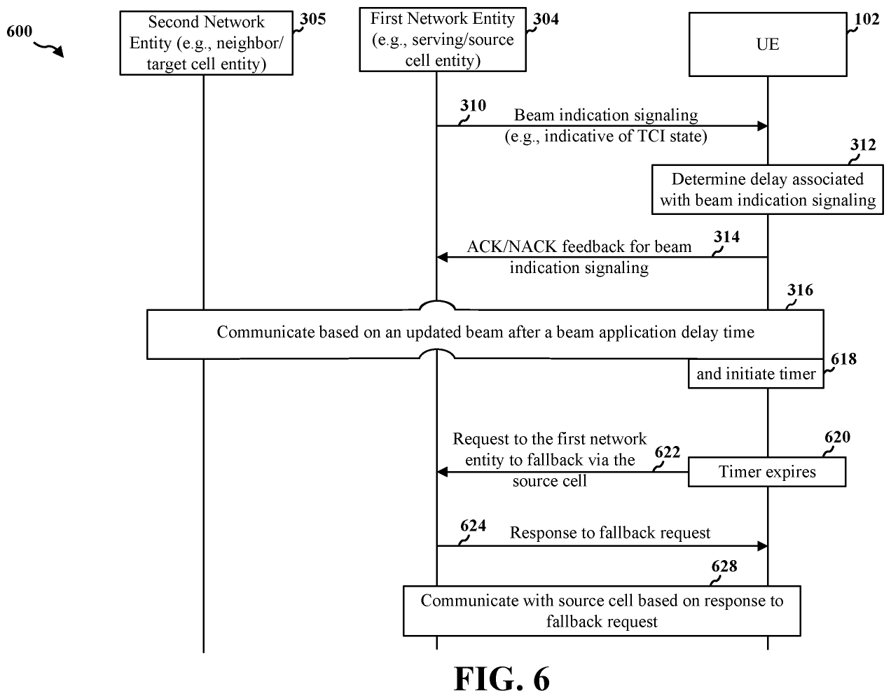

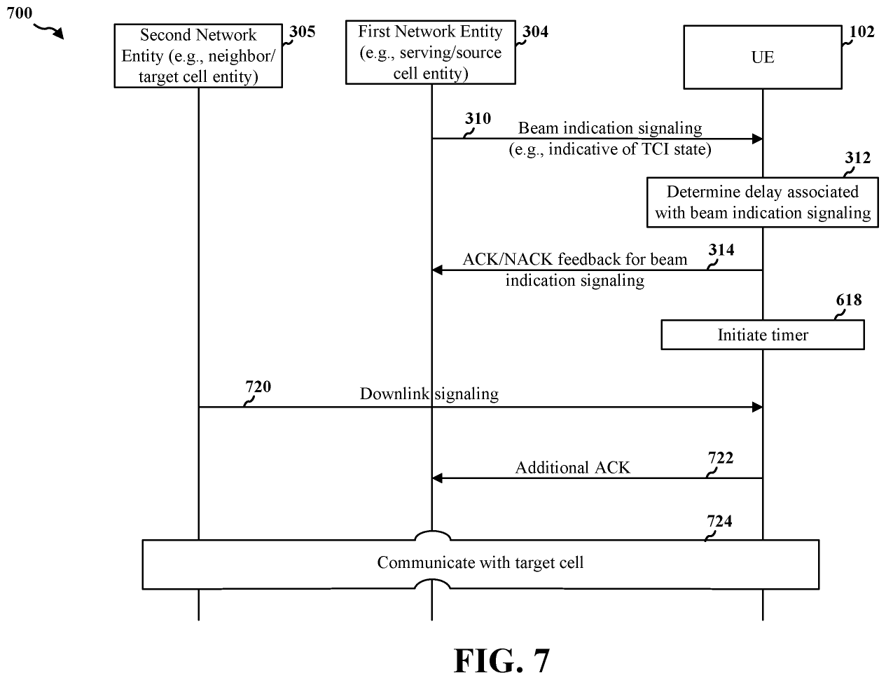

FIG. 6 is a communication signaling diagram 600 illustrating communications between the UE 102 and the first/second network entities 304-305 when the UE 102 performs a timer-based fallback operation to the first network entity 304 based on a layer 1/layer 2 (L1/L2) ICM failure. Refer to FIG. 7 for details regarding a successful handover procedure.

Elements 310, 312, 314 of FIG. 6 and FIG. 3 correspond to each other. For example, when the updated beam corresponds to a beam of the second network entity 305 for the ICM procedure, the UE 102 determines a beam application time to be used for the ICM procedure. As another example, when the TCI state associated with the beam indication signaling received 310 from the first network entity 304 is indicative of the ICM procedures (e.g. RRC parameter update), the UE 102 determines 312 that the delay corresponds to the ICM procedures. For updated beams associated with ICM procedures, the UE 102 applies the indicated beam based on the beam application delay time determined 312 for the ICM procedures and communicates 316 with the second network entity 305 based on an updated beam after the beam application delay time associated with the ICM procedures. For example, the communication 316 may be based on the second network entity 305 transmitting signaling that is not dedicated to the UE 102 (i.e., signaling that is not associated with a handover procedure that causes the target network entity/base station to become the serving network entity/base station).

The UE 102 initiates 618 a timer for a fallback procedure to the first network entity 304. The UE 102 might use the timer to resolve missed detections from the second network entity 305 or incorrect detections of the beam indication signaling being associated with the ICM procedure for which the UE transmitted 314 the ACK/NACK feedback to the first network entity.

Communications between the UE 102 and the first network entity 304 may correspond to a source cell. The UE 102 receives 310 the beam indication signaling while the first network entity 304 is associated with the source cell, where the beam indication signaling is indicative of the TCI state associated with the target cell of the second network entity 305. Such beam indication signaling corresponds an L1/L2 ICM procedure. The UE 102 may initiate a first timer for the ICM procedure with the target cell (e.g., second network entity 305) in response to the beam indication signaling received 310 from the source cell (e.g., first network entity 304). The UE 102 may initiate the first timer for the ICM procedure with the target cell after the beam application delay time for the TCI associated with the target cell. Alternatively, the UE 102 may initiate the first timer for the ICM procedure with the target cell upon receiving 310 the beam indication signaling from the first network entity 304.

If the UE 102 detects a downlink signal (e.g., non-UE-dedicated signaling) from the target cell (e.g. PDCCH), the UE 102 determines that the target cell becomes a serving cell and stops the first timer. The UE 102 may maintain a radio link with the source cell while monitoring for the downlink signal (e.g., non-UE-dedicated signaling) from the target cell and/or the UE 102 may terminate the radio link based on transmitting 314 the ACK/NACK feedback to the first network entity 304.

The first timer might expire 620 before the UE 102 stops the timer. An expiration of the first timer is indicative of an L1/L2 ICM failure. Hence, if the first timer expires 620 the UE 102 may perform a fallback operation to the source cell to resume communications with the first network entity 304 based on the source cell. The first network entity 304 may configure a duration of the first timer to the UE 102 via RRC signaling (not shown; occurs after or in association with 310). For example, the first network entity 304 transmits an RRC reconfiguration message to the UE 102 including a first timer value for the first timer. In further examples, the first network entity 304 may broadcast a system information block (SIB) including the first timer value. The SIB may correspond to a SIBI or other type of SIB for indicating the first timer value. The first network entity 304 may configure the first timer value for individual first timers for each target cell that is a candidate for the ICM procedure. Alternatively, the first network entity 304 may configure the first timer value for the first timer commonly across the candidate/target cells. In still further examples, the UE 102 may use a default, preconfigured or predetermined timer value for the first timer.

The fallback procedure to the first network entity 304 may be based on a random access procedure, such as a contention-free random access (CFRA) procedure or a contention-based random access (CBRA) procedure. When the first timer expires, the UE 102 may trigger the random access procedure toward the source cell associated with the first network entity 304. The random access procedure might be a four-step random access procedure, where the UE 102 might include a cell-radio network temporary identifier (C-RNTI) used for the source cell in a message 3 (Msg3) of the four-step random access procedure. Alternatively, the random access procedure may be a two-step random access procedure, where the UE 102 might include the C-RNTI used for the source cell in a message A (MsgA) of the two-step random access procedure. The first network entity 304 might identify that the fallback procedure is triggered by the UE 102 when the first network entity 304 receives the C-RNTI in the random access procedure via the source cell. The fallback operation may be triggered based on a failure of the L1/L2 ICM for the target cell, where the UE 102 indicates the failure to the first network entity 304 via the source cell. For example, the UE 102 transmits 622 a request to the first network entity 304 to fallback to communicating with the first network entity 304 via the source cell.

The UE 102 may refrain from initiating an RRC connection reestablishment procedure in response to the L1/L2 ICM failure. That is, the UE may refrain from transmitting an RRC message (e.g., RRCReestablishmentRequest message) in the Msg3 or MsgA transmitted to the first network entity. As such, the first network entity 304 is not triggered by the UE 102 to perform the RRC connection reestablishment procedure with the UE 102 based on the L1/L2 ICM failure. Performing the RRC connection reestablishment procedure might cause the UE 102 and the first network entity 304 to reset radio configuration parameters, such that the first network entity 304 might reconfigure the parameters from the beginning of the radio link and cause increased latency om communications between the UE 102 and the first network entity 304.

The UE 102 might initiate a second timer (not shown) based on detection of the L1/L2 ICM failure. The first timer corresponds to a first time duration value received 310 along with the beam indication signaling. The first timer initiates 618 when the UE starts attempting to receive non-UE-dedicated signaling from the second network entity 305, where an expiration of the first timer prior to the neighbor/target cell entity becoming the serving cell entity results in the L1/L2 ICM failure. The second timer, which the UE 102 may initiate at a same time as the first timer, corresponds to a second timer duration (e.g., longer than the first time duration) The UE 102 performs an RRC connection reestablishment procedure (not shown) after the L1/L2 ICM failure and upon the expiration of the second timer. The first network entity 304 may transmit an RRC reconfiguration message to the UE 102 including a second timer value for the second timer. As another example, the first network entity broadcasts a SIB including the second timer value. The SIB may correspond to a SIB1 or other type of SIB indicating the second timer value. The second timer value is longer than the first timer value so that the second timer does not expire before the first timer.

If the UE 102 detects a downlink signal (e.g., non-UE-dedicated signaling), such as DCI, from the target cell on a PDCCH, the UE 102 determines that the target cell has become the serving cell and stops the second timer. If the second timer expires before the UE 102 stops the second timer, the UE 102 initiates an RRC connection reestablishment procedure. The UE 102 may perform the RRC connection reestablishment procedure on the source cell, the target cell, or a different cell from the source cell and the target cell. The UE 102 might transmit or receive an RRC reestablishment request message (e.g., RRCReestablishmentRequest message) on a cell, such as the source cell, the target cell, or the different cell, for the RRC connection reestablishment procedure. The UE 102 might also transmit or receive an RRC reestablishment complete message (e.g., RRCReestablishmentComplete message) on the cell, such as the source cell, the target cell, or the different cell. In examples, the UE 102 initiates the second timer only if the target cell corresponds to a target PCell or a target PSCell. Alternatively, the UE 102 may initiate the second timer regardless of whether the target cell corresponds to a PCell, PSCell, or an SCell.

The request transmitted 622 from the UE 102 to the first network entity 304 may be transmitted on a PUCCH or a PUSCH. For example, the control signaling transmitted after or in association with the beam indication signaling may include an RRC reconfiguration message that configures the resources for the PUCCH or the PUSCH on which the UE 102 transmits 622 the fallback request. After the first network entity 304 receives 622 the fallback request from the UE 102, the first network entity can transmit 624 a response to the fallback request. The response to the fallback request might be transmitted 624 on a PDCCH from the first network entity 304 to the UE 102. The PDCCH may be a PDCCH in a dedicated SS or CORESET that the first network entity 304 configures for the UE 102 based on higher layer signaling, such as a SIB or an RRC reconfiguration message. Alternatively, the PDCCH may be a PDCCH associated with a particular radio network temporary identifier (RNTI) that the first network entity 304 configures to the UE 102 based on the higher layer signaling. In further examples, the PDCCH may be a PDCCH associated with a dedicated DCI format, or a PDCCH that schedules a transmission based on a same HARQ process as used for a PUSCH associated with the fallback request.

The UE 102 communicates 628 with the source cell based on the response to the fallback requested received 624 from the first network entity 304. FIG. 6 described a fallback procedure, while FIG. 7 will describe a successful handover procedure.

FIG. 7 is a communication signaling diagram 700 illustrating communications between the UE 102 and the first/second network entities 304-305 supporting source and target cells conducting a successful handover using beam indication techniques for ICM. Elements 310, 312, 314, 618 of FIG. 7 and FIG. 6 correspond to each other.

The UE 102 may confirm reception 720 of downlink signaling, such as a reference signal or other UE-dedicated signaling, from the target cell/second network entity 305 for the ICM procedure based on transmission 722 of an ACK to the source cell/first network entity 304. The ACK transmitted 722 to the first network entity 304 is a different ACK (e.g., additional ACK) from the ACK/NACK feedback transmitted 314 to the first network entity 304 in response to the beam indication signaling. The ACK indicates to the first network entity 304 that the ICM procedure between the UE 102 and the first/second network entities 304-305 is performed successfully. If the UE 102 detects/receives 720 a downlink signal (e.g. PDCCH) for the UE 102 from the target cell, the UE 102 determines that the target cell becomes a serving cell and stops the timer. An expiration of the timer before the UE 102 terminates the timer is indicative of an L1/L2 ICM failure. As shown in FIG. 6, the UE 102 might perform a fallback operation to the source cell, based on the L1/L2 ICM failure, to resume communications with the first network entity 304 via the source cell.

The UE 102 may perform a CFRA procedure or a CBRA procedure to transmit 722 the additional ACK to the first network entity 304. The CBRA procedure might be a four-step random access procedure or a two-step random access procedure. The four-step CBRA procedure might include the UE 102 transmitting 722 the additional ACK in a Msg3 of the random access procedure. The two-step CBRA procedure might include the UE 102 transmitting 722 the additional ACK in a MsgA of the random access procedure. For the CFRA procedure, the second network entity 305 might configure a PRACH resource based on RRC signaling or DCI from the target cell.

Alternatively, the UE 102 may transmit 722 the additional ACK on a PUCCH or a PUSCH configured based on the RRC signaling or triggered by DCI from the target cell. If the additional ACK is transmitted 722 on a PUSCH, the UE 102 may send the additional ACK in a MAC-CE or multiplex the additional ACK with other uplink control information in the PUSCH. Alternatively, the second network entity 305 (e.g., target cell) may transmit the additional ACK to the first network entity 304 (e.g., source cell) over a backhaul link/Xn interface between the second network entity 305 and the first network entity 304. The second network entity 305 might transmit the additional ACK over the backhaul link/Xn interface to the first network entity 304 based on receiving an uplink signal, such as a PUCCH, PUSCH, or PRACH, from the UE 102. After the first network entity 304 receives the additional ACK, cither from the UE 102 or via the backhaul link/Xn interface from the second network entity, the UE 102 may communicate 724 with the target cell based on the indicated beam for the ICM procedure.

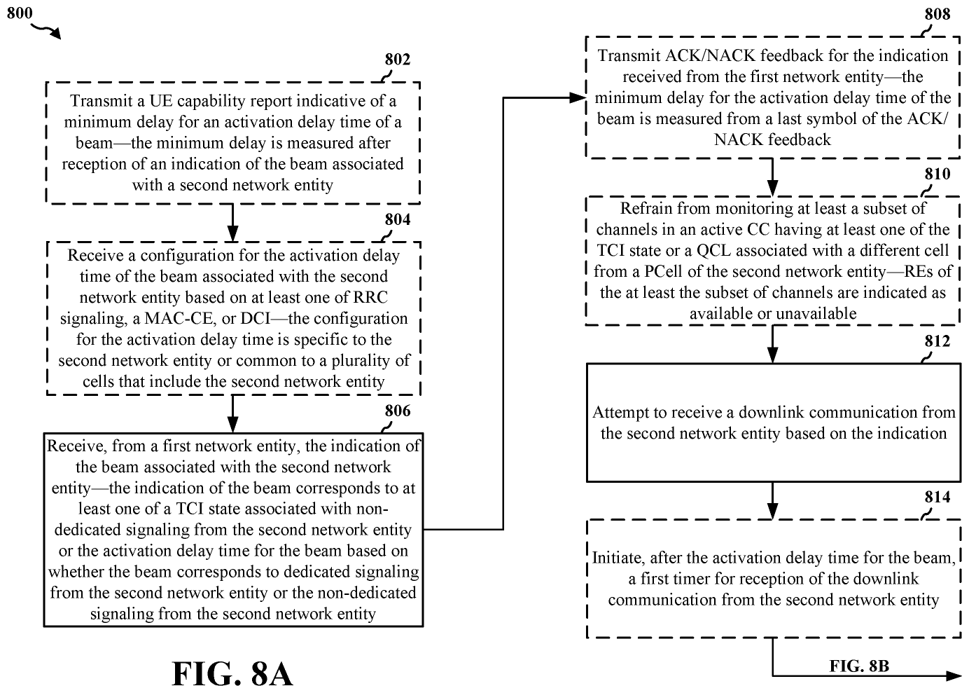

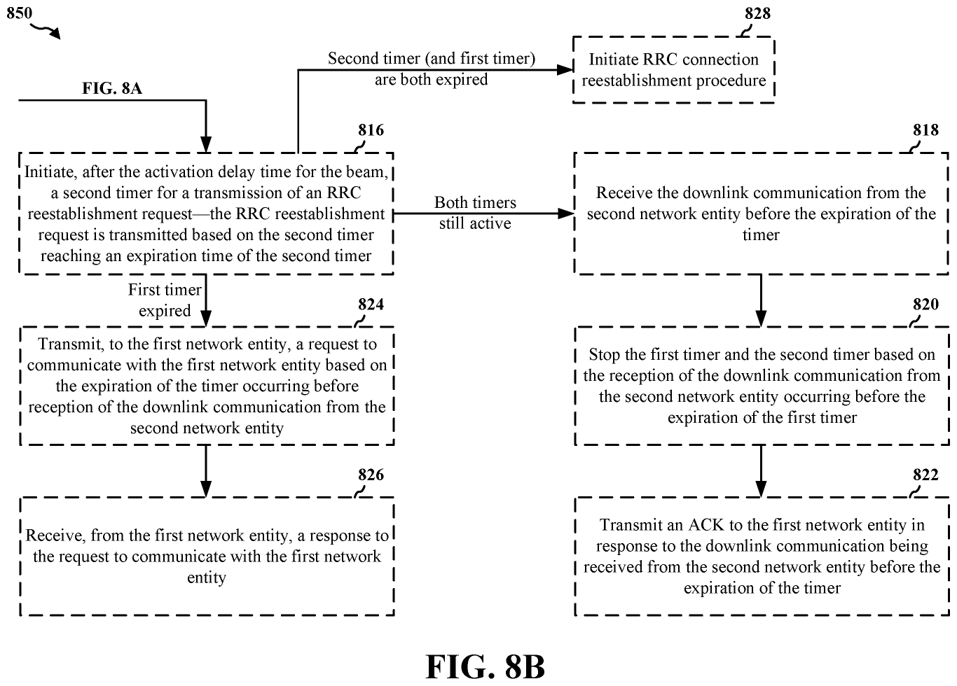

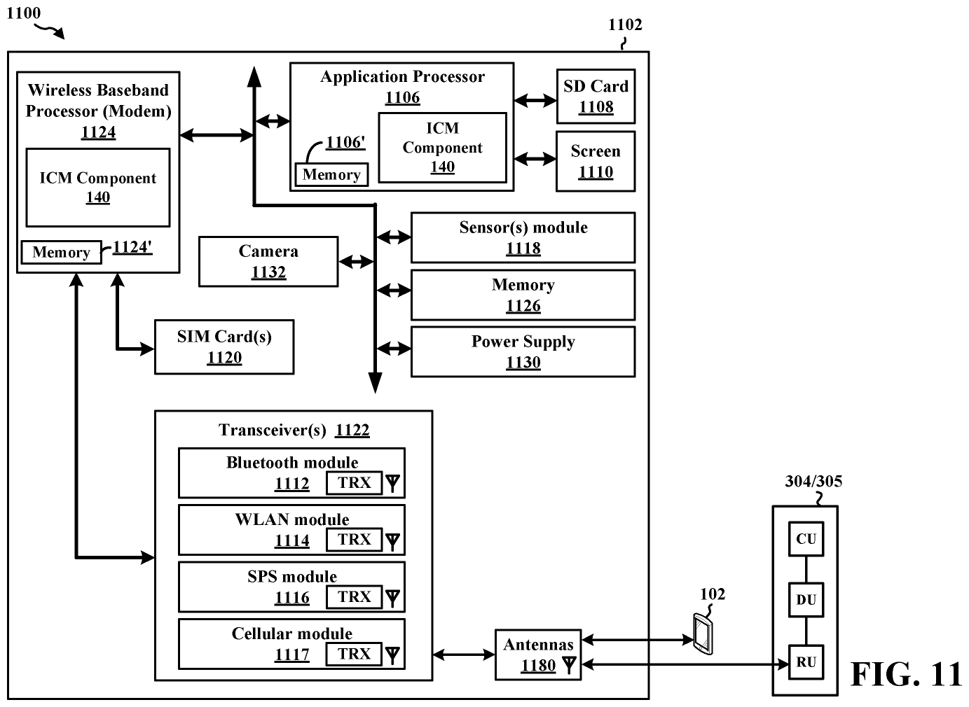

FIGS. 8A-8B illustrate flowcharts 800-850 of a method of wireless communication. With reference to FIGS. 1 and 11, the method may be performed by the UE 102, the apparatus 1102, etc., which may include the memory 1124′ and which may correspond to the entire UE 102 or the apparatus 1102, or a component of the UE 102 or the apparatus 1102, such as the wireless baseband processor 1124, and/or the application processor 1106.

The UE 102 transmits 802 a UE capability report indicative of a minimum delay for an activation delay time of a beam—the minimum delay is measured after reception of an indication of the beam associated with a second network entity. For example, referring to FIG. 3, the UE 102 transmits 306 a UE capability report for a minimum beam application delay for ICM to the first network entity 304. The transmission 802 may be performed by the ICM component 140 of the UE 102 or the apparatus 1102.

The UE 102 receives 804 a configuration for the activation delay time of the beam associated with the second network entity based on at least one of RRC signaling, a MAC-CE, or DCI—the configuration for the activation delay time is specific to the second network entity or common to a plurality of cells that include the second network entity. For example, referring to FIG. 3, the UE 102 receives 308 a configuration for a beam application delay for ICM from the first network entity 304. The reception 804 may be performed by the ICM component 140 of the UE 102 or the apparatus 1102.

The UE 102 receives 806, from a first network entity, the indication of the beam associated with the second network entity—the indication of the beam corresponds to at least one of a TCI state associated with non-dedicated signaling from the second network entity or the activation delay time for the beam based on whether the beam corresponds to dedicated signaling from the second network entity or the non-dedicated signaling from the second network entity. For example, referring to FIGS. 3-4 and 6-7, the UE 102 receives 310 beam indication signaling from the first network entity 304. The beam indication signaling 304 may be indicative of a TCI state. The reception 806 may be performed by the ICM component 140 of the UE 102 or the apparatus 1102.

The UE 102 transmits 808 ACK/NACK feedback for the indication received from the first network entity—the minimum delay for the activation delay time of the beam may be measured from a last symbol of the ACK/NACK feedback. For example, referring to FIGS. 3-4 and 6-7, the UE 102 transmits 314 ACK/NACK feedback to the first network entity 304 for the beam indication signaling received 310 from the first network entity 304. The transmission 802 may be performed by the ICM component 140 of the UE 102 or the apparatus 1102.

The UE 102 refrains 810 from monitoring at least a subset of channels in an active CC having at least one of the TCI state or a QCL associated with a different cell from a PCell of the second network entity—REs of the at least the subset of channels are indicated as available or unavailable. For example, referring to FIG. 5, the UE 102 refrains from monitoring CCs based on the PCell indication diagram 500 associated with ICM procedure. The refraining 810 may be performed by the ICM component 140 of the UE 102 or the apparatus 1102.

The UE 102 attempts 812 to receive a downlink communication from the second network entity based on the indication. For example, referring to FIGS. 3-4 and 6, the UE 102 attempts to communicate 316 with the second network entity 305 based on an updated beam after the beam application delay time. In the communication signaling diagram 400, the UE 102 attempts to communicate 422 with the second network entity 305 based on the indicated TCI state. The attempt 812 may be performed by the ICM component 140 of the UE 102 or the apparatus 1102.

The UE 102 initiates 814, after the activation delay time for the beam, a first timer for reception of the downlink communication from the second network entity. For example, referring to FIGS. 6-7, the UE 102 initiates one or more timers 618, such as a timer for reception of a downlink communication from the second network entity 305. The initiation 814 may be performed by the ICM component 140 of the UE 102 or the apparatus 1102.

The UE 102 initiates 816, after the activation delay time for the beam, a second timer for a transmission of an RRC reestablishment request—the RRC reestablishment request is transmitted based on the second timer reaching an expiration time of the second timer. For example, referring to FIGS. 6-7, the UE 102 initiates one or more timers 618, such as a timer for an RRC reestablishment request with the first network entity 304. The initiation 816 may be performed by the ICM component 140 of the UE 102 or the apparatus 1102.

The second timer is initiated 816 at the same time as the first timer and is longer than the first timer. If both timers are still active, the UE 102 receives 818 the downlink communication from the second network entity before the expiration of the timer. For example, referring to FIG. 7, the UE 102 receives 720 downlink signaling from the second network entity 305. The reception 818 may be performed by the ICM component 140 of the UE 102 or the apparatus 1102.

The UE 102 stops 820 the first timer and the second timer based on the reception of the downlink communication from the second network entity occurring before the expiration of the first timer. For example, referring to FIG. 7, the UE 102 stops the first timer and the second timer initiated 618 based on reception 720 of the downlink signaling from the second network entity 305. The stopping 820 may be performed by the ICM component 140 of the UE 102 or the apparatus 1102.

The UE 102 transmits 822 an ACK to the first network entity in response to the downlink communication being received from the second network entity before the expiration of the timer. For example, referring to FIG. 7, the UE 102 transmits 722 and additional ACK to the first network entity 304 in response to the downlink signaling received 720 from the second network entity 305. The transmission 822 may be performed by the ICM component 140 of the UE 102 or the apparatus 1102.

If the first timer expires, the UE 102 transmits 824, to the first network entity, a request to communicate with the first network entity based on the expiration of the timer occurring before reception of the downlink communication from the second network entity. For example, referring to FIG. 6, the UE 102 transmits 622 a request to the first network entity 304 to fall back to the first network entity 304 via the source cell. The request is transmitted 622 based on the timer expiring 620 prior to reception of a downlink communication from the second network entity 305. The transmission 824 may be performed by the ICM component 140 of the UE 102 or the apparatus 1102.

The UE 102 receives 826, from the first network entity, a response to the request to communicate with the first network entity. For example, referring to FIG. 6, the UE 102 receives 624 a response to the fallback request from the first network entity 304 that was transmitted 622 to the first network entity 304 from the UE 102. The reception 826 may be performed by the ICM component 140 of the UE 102 or the apparatus 1102.

If the second timer and the first timer both expire (based on the second timer being longer than the first timer and both timers being initiated at the same time), the UE 102 initiates 828 an RRC connection reestablishment procedure. The UE 102 may perform the RRC connection reestablishment procedure on the source cell, the target cell, or a different cell from the source cell and the target cell. The initiation 828 may be performed by the ICM component 140 of the UE 102 or the apparatus 1102.

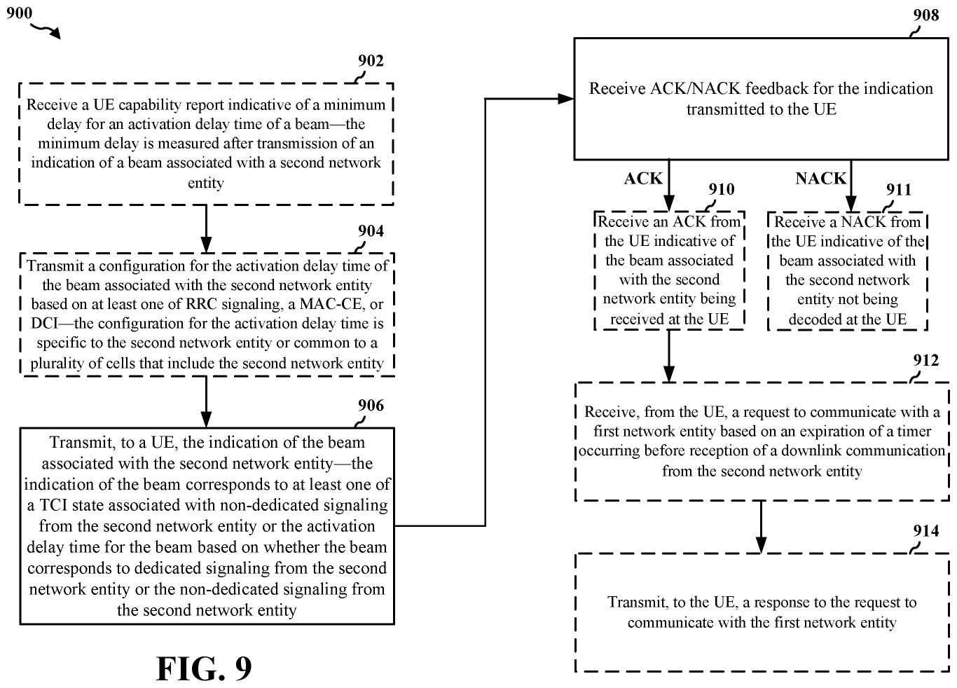

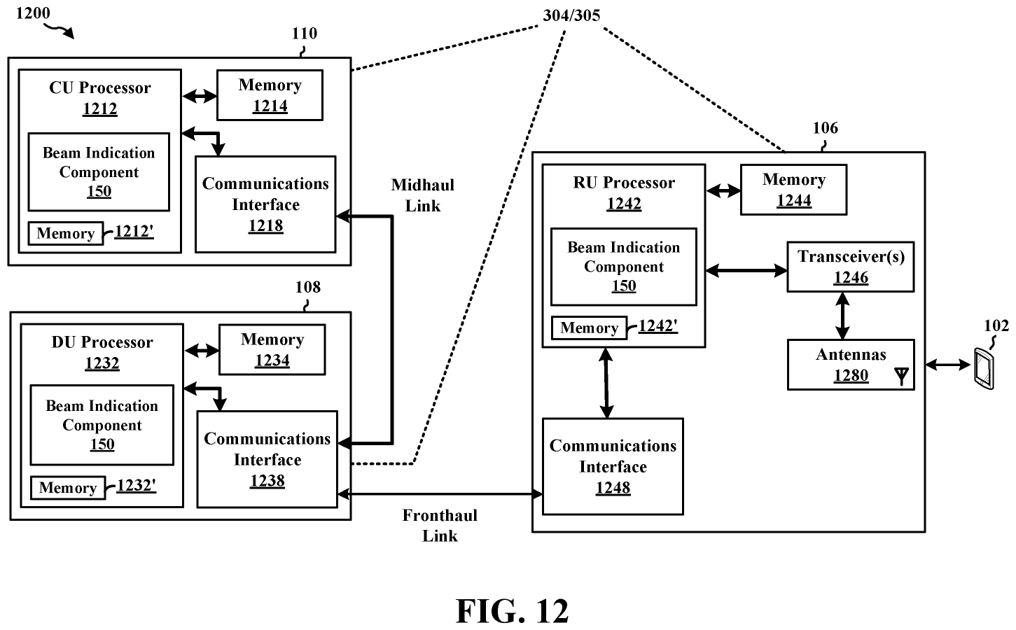

FIG. 9 is a flowchart 900 of a method of wireless communication at a first network entity providing a serving/source cell. With reference to FIGS. 1 and 12, the method may be performed by the base station 104 or an entity at the base station 104, such as the first network entity 304, which may correspond to the RU 106, the DU 108, the CU 110, the RU processor 1242, the DU processor 1232, or the CU processor 1212, etc. The base station 104 or the entity at the base station 104 may include the memory 1212′/1232′/1242′, which may correspond to the entire first network entity 304 or the base station 104, or a component of the first network entity 304 or the base station 104, such as the RU processor 1242, the DU processor 1232, or the CU processor 1212.

The first network entity 304 or the base station 104 receives 902 a UE capability report indicative of a minimum delay for an activation delay time of a beam—the minimum delay is measured after transmission of an indication of a beam associated with a second network entity. For example, referring to FIG. 3, the first network entity 304 receives 306 a UE capability report for a minimum beam application delay for ICM from the UE 102. The reception 902 may be performed by the beam indication component 150 of the base station 104 or the first network entity 304 at the base station 104, such as the RU 106, the DU 108, and/or the CU 110.

The first network entity 304 or the base station 104 transmits 904 a configuration for the activation delay time of the beam associated with the second network entity based on at least one of RRC signaling, a MAC-CE, or DCI—the configuration for the activation delay time is specific to the second network entity or common to a plurality of cells that include the second network entity. For example, referring to FIG. 3, the first network entity 304 transmits 308 a configuration for a beam application delay for ICM to the UE 102. The transmission 904 may be performed by the beam indication component 150 of the base station 104 or the first network entity 304 at the base station 104, such as the RU 106, the DU 108, and/or the CU 110.

The first network entity 304 or the base station 104 transmits 906, to a UE, the indication of the beam associated with the second network entity—the indication of the beam corresponds to at least one of a TCI state associated with non-dedicated signaling from the second network entity or the activation delay time for the beam based on whether the beam corresponds to dedicated signaling from the second network entity or the non-dedicated signaling from the second network entity. For example, referring to FIGS. 3-4 and 6-7, the first network entity 304 transmits 310 beam indication signaling to the UE 102. The beam indication signaling 304 may be indicative of a TCI state. The transmission 906 may be performed by the beam indication component 150 of the base station 104 or the first network entity 304 at the base station 104, such as the RU 106, the DU 108, and/or the CU 110.

The first network entity 304 or the base station 104 receives 908 ACK/NACK feedback for the indication transmitted to the UE. For example, referring to FIGS. 3-4 and 6-7, the first network entity 304 receives 314 ACK/NACK feedback from the UE 102 for the beam indication signaling transmitted 310 to the UE 102. The reception 908 may be performed by the beam indication component 150 of the base station 104 or the first network entity 304 at the base station 104, such as the RU 106, the DU 108, and/or the CU 110.

The first network entity 304 or the base station 104 receives 910 an ACK from the UE indicative of the beam associated with the second network entity being received at the UE. For example, referring to FIG. 7, the first network entity 304 receives 722 and additional ACK from the UE 102 associated with the downlink signaling transmitted 720 from the second network entity 305 to the UE102. Alternatively, the network entity 304 or the base station 104 receives 911 a NACK from the UE indicative of the beam associated with the second network entity not being decoded at the UE. The reception(s) 910-911 may be performed by the beam indication component 150 of the base station 104 or the first network entity 304 at the base station 104, such as the RU 106, the DU 108, and/or the CU 110.

The first network entity 304 or the base station 104 receives 912 from the UE, a request to communicate with a first network entity based on an expiration of a UE-side timer occurring before reception of a downlink communication from the second network entity. For example, referring to FIG. 6, the first network entity 304 receives 622 a request from the UE 102 to fallback to communication with the first network entity 304 via the source cell. The request is received 622 based on the UE timer expiring 620 prior to reception of a downlink communication from the second network entity 305 to the UE 102. The reception 912 may be performed by the beam indication component 150 of the base station 104 or the first network entity 304 at the base station 104, such as the RU 106, the DU 108, and/or the CU 110.

The first network entity 304 or the base station 104 transmits 914, to the UE, a response to the request to communicate with the first network entity. For example, referring to FIG. 6, the first network entity 304 transmits 624 a response to the UE 102 to the fallback request received 622 from the UE 102. The transmission 914 may be performed by the beam indication component 150 of the base station 104 or the first network entity 304 at the base station 104, such as the RU 106, the DU 108, and/or the CU 110.

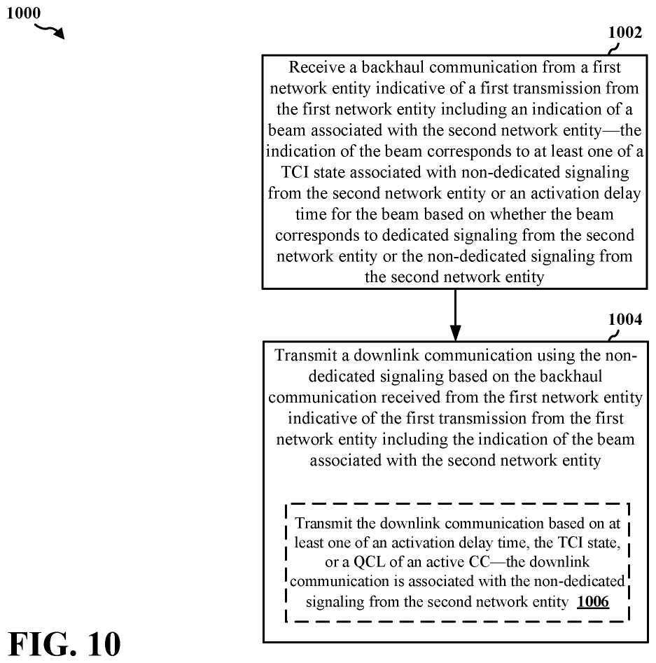

FIG. 10 is a flowchart 1000 of a method of wireless communication at a second network entity providing a neighbor/target cell. The method may be performed by the base station 104 or an entity at the base station 104, such as the second network entity 305, which may correspond to the RU 106, the DU 108, the CU 110, the RU processor 1242, the DU processor 1232, or the CU processor 1212, etc. With reference to FIG. 12, the base station 104 or the entity at the base station 104 may include the memory 1212′/1232′/1242′, which may correspond to the entire second network entity 305 or the base station 104, or a component of the second network entity 305 or the base station 104, such as the RU processor 1242, the DU processor 1232, or the CU processor 1212.

The second network entity 305 or the base station 104 receives 1002 a backhaul communication from a first network entity indicative of a first transmission from the first network entity including an indication of a beam associated with the second network entity—the indication of the beam corresponds to at least one of a TCI state associated with non-dedicated signaling from the second network entity or an activation delay time for the beam based on whether the beam corresponds to dedicated signaling from the second network entity or the non-dedicated signaling from the second network entity. For example, referring to FIG. 3, the second network entity 305 receives 309 a backhaul communication from the first network entity 304 over an Xn interface. The backhaul communication received 309 from the first network entity 304 is indicative of the beam indication signaling transmitted 310 from the first network entity 304 to the UE 102. The beam indication signaling is associated with a beam of the second network entity 305. The reception 1002 may be performed by the beam indication component 150 of the base station 104 or the second network entity 305 at the base station 104, such as the RU 106, the DU 108, and/or the CU 110.

The second network entity 305 or the base station 104 transmits 1004 a downlink communication using the non-dedicated signaling based on the backhaul communication received from the first network entity indicative of the first transmission from the first network entity including the indication of the beam associated with the second network entity. For example, referring to FIGS. 3-4 and 6, the second network entity 305 communicates 316 with the UE 102 based on an updated beam after the beam application delay time. In the communication signaling diagram 400, the second network entity 305 communicates 422 with the UE 102 based on the indicated TCI state. The transmission 1004 may be performed by the beam indication component 150 of the base station 104 or the second network entity 305 at the base station 104, such as the RU 106, the DU 108, and/or the CU 110.

The second network entity 305 or the base station 104 transmits 1006 the downlink communication based on at least one of an activation delay time, the TCI state, or a QCL of an active CC—the downlink communication is associated with the non-dedicated signaling from the second network entity. For example, referring to FIGS. 3 and 7, the second network entity 305 transmits 720 the downlink signaling to the UE 102 based on the backhaul communication received 309 from the first network entity 304 indicative of the beam indication signaling. The transmission 1006 may be performed by the beam indication component 150 of the base station 104 or the second network entity 305 at the base station 104, such as the RU 106, the DU 108, and/or the CU 110. A UE apparatus 1102, as described in FIG. 11, may perform the method of flowcharts 800-850, a first network entity 304, such as described in FIG. 12, may perform the method of flowchart 900, and a second network entity 305, such as also described in FIG. 12, may perform the method of flowchart 1000.

FIG. 11 is a diagram 1100 illustrating an example of a hardware implementation for a UE apparatus 1102. The apparatus 1102 may be a UE 102, a component of a UE, or may implement UE functionality. In some aspects, the apparatus 1102 may include a wireless baseband processor 1124 (also referred to as a modem) coupled to one or more transceivers 1122 (e.g., wireless RF transceiver). The wireless baseband processor 1124 may include on-chip memory 1124′. In some aspects, the apparatus 1102 may further include one or more subscriber identity modules (SIM) cards 1120 and an application processor 1106 coupled to a secure digital (SD) card 1108 and a screen 1110. The application processor 1106 may include on-chip memory 1106′.

The apparatus 1102 may further include a Bluetooth module 1112, a WLAN module 1114, an SPS module 1116 (e.g., GNSS module), and a cellular module 1117 within the one or more transceivers 1122. The Bluetooth module 1112, the WLAN module 1114, the SPS module 1116, and the cellular module 1117 may include an on-chip transceiver (TRX) (or in some cases, just a receiver (RX)). The Bluetooth module 1112, the WLAN module 1114, the SPS module 1116, and the cellular module 1117 may include their own dedicated antennas and/or utilize the antennas 1180 for communication. The apparatus 1102 may further include one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1126, a power supply 1130, and/or a camera 1132.

The wireless baseband processor 1124 communicates through the transceiver(s) 1122 via one or more antennas 1180 with another UE 102 and/or with an RU associated with a network entity 304/305. The wireless baseband processor 1124 and the application processor 1106 may each include a computer-readable medium/memory 1124′, 1106′, respectively. The additional modules of memory 1126 may also be considered a computer-readable medium/memory. Each computer-readable medium/memory 1124′, 1106′, 1126 may be non-transitory. The wireless baseband processor 1124 and the application processor 1106 are each responsible for general processing, including the execution of software stored on the computer-readable medium/memory. The software, when executed by the wireless baseband processor 1124/application processor 1106, causes the wireless baseband processor 1124/application processor 1106 to perform the various functions described. The computer-readable medium/memory may also be used for storing data that is manipulated by the wireless baseband processor 1124/application processor 1106 when executing software. The wireless baseband processor 1124/application processor 1106 may be a component of the UE 102. The apparatus 1102 may be a processor chip (modem and/or application) and include just the wireless baseband processor 1124 and/or the application processor 1106, and in another configuration, the apparatus 1102 may be the entire UE 102 and include the additional modules of the apparatus 1102.

As discussed, the ICM component 140 is configured to receive, from a first network entity, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to a UE or the non-dedicated signaling from the second network entity; and attempt to receive a downlink communication from the second network entity based on the indication. The ICM component 140 may be within the wireless baseband processor 1124, the application processor 1106, or both the wireless baseband processor 1124 and the application processor 1106. The ICM component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1102 may include a variety of components configured for various functions. In one configuration, the apparatus 1102, and in particular the wireless baseband processor 1124 and/or the application processor 1106, includes means for receiving, from a first network entity, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to the UE or the non-dedicated signaling from the second network entity; and means for attempting to receive a downlink communication from the second network entity based on the indication. The apparatus 1102 further includes means for transmitting a UE capability report indicative of a minimum delay for the activation delay time of the beam, the minimum delay being measured after reception of the indication of the beam associated with the second network entity. The apparatus 1102 further includes means for transmitting ACK/NACK feedback for the indication received from the first network entity, the minimum delay for the activation delay time of the beam being measured from a last symbol of the ACK/NACK feedback. The apparatus 1102 further includes means for receiving a configuration for the activation delay time of the beam associated with the second network entity based on at least one of RRC signaling, a MAC-CE, or DCI, the configuration for the activation delay time being specific to the second network entity or common to a plurality of cells that include the second network entity.

In further aspects, the apparatus 1102, and in particular the wireless baseband processor 1124 and/or the application processor 1106, includes means for refraining from monitoring at least a subset of channels in an active CC having at least one of the TCI state or a QCL associated with a different cell from the PCell of the second network entity, REs of the at least the subset of channels being indicated as available or unavailable. The apparatus 1102 further includes means for receiving the downlink communication from the second network entity based on the at least one of the activation delay time, the TCI state, or the QCL of the active CC, the downlink communication associated with the non-dedicated signaling from the second network entity. The apparatus 1102 further includes means for initiating, after the activation delay time for the beam, a timer for reception of the downlink communication from the second network entity; and means for stopping the first timer and the second timer based on the reception of the downlink communication from the second network entity occurring before an expiration of the first timer. The apparatus 1102 further includes means for receiving the downlink communication from the second network entity before the expiration of the timer; and means for transmitting an ACK to the first network entity in response to the downlink communication being received from the second network entity before the expiration of the timer. The apparatus 1102 further includes means for transmitting, to the first network entity, a request to communicate with the first network entity based on the expiration of the timer occurring before the reception of the downlink communication from the second network entity; and means for receiving, from the first network entity, a response to the request to communicate with the first network entity. The apparatus 1102 further includes means for initiating, after the activation delay time for the beam, a second timer for a second transmission of an RRC reestablishment request, the RRC reestablishment request being transmitted based on the second timer reaching an expiration time of the second timer. The means may be the ICM component 140 of the apparatus 1102 configured to perform the functions recited by the means.

FIG. 12 is a diagram 1200 illustrating an example of a hardware implementation for a network entity 304/305. The network entity 304/305 may be a BS, a component of a BS, or may implement BS functionality. The network entity 304/305 may include at least one of a CU 110, a DU 108, or an RU 106. For example, depending on the layer functionality handled by the beam indication component 150, the network entity 304/305 can include the CU 110; both the CU 110 and the DU 108; each of the CU 110, the DU 108, and the RU 106; the DU 108; both the DU 108 and the RU 106; or the RU 106.

The CU 110 may include a CU processor 1212. The CU processor 1212 may include on-chip memory 1212′. In some aspects, the CU 110 may further include additional memory modules 1214 and a communications interface 1218. The CU 110 communicates with the DU 108 through a midhaul link, such as an F1 interface. The DU 108 may include a DU processor 1232. The DU processor 1232 may include on-chip memory 1232′. In some aspects, the DU 108 may further include additional memory modules 1234 and a communications interface 1238. The DU 108 communicates with the RU 106 through a fronthaul link. The RU 106 may include an RU processor 1242. The RU processor 1242 may include on-chip memory 1242′. In some aspects, the RU 106 may further include additional memory modules 1244, one or more transceivers 1246, antennas 1280, and a communications interface 1248. The RU 106 communicates wirelessly with the UE 102.

The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described. The computer-readable medium/memory may also be used for storing data that is manipulated by the processor(s) when executing software.

As discussed, the beam indication component 150 is configured to transmit, to a UE, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to the UE or the non-dedicated signaling from the second network entity; and receive ACK/NACK feedback for the indication transmitted to the UE. In further aspects, the beam indication component 150 is configured to receive a backhaul communication from a first network entity indicative of a first transmission from the first network entity including an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to a UE or the non-dedicated signaling from the second network entity; and transmits a downlink communication using the non-dedicated signaling based on the backhaul communication received from the first network entity indicative of the first transmission from the first network entity including the indication of the beam associated with the second network entity. The beam indication component 150 may be within one or more processors of one or more of the CU 110, DU 108, and the RU 106. The beam indication component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 304/305 may include a variety of components configured for various functions. In one configuration, the network entity 304/305 includes means for transmitting, to a UE, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to the UE or the non-dedicated signaling from the second network entity; and means for receiving ACK/NACK feedback for the indication transmitted to the UE. The network entity 304/305 further includes means for receiving a UE capability report indicative of a minimum delay for the activation delay time of the beam, the minimum delay being measured after transmission of the indication of the beam associated with the second network entity. The network entity 304/305 further includes means for transmitting a configuration for the activation delay time of the beam associated with the second network entity based on at least one of RRC signaling, a MAC-CE, or DCI, the configuration for the activation delay time being specific to the second network entity or common to a plurality of cells that include the second network entity. The network entity 304/305 further includes means for receiving an ACK from the UE indicative of the beam associated with the second network entity being received at the UE. The network entity 304/305 further includes means for receiving, from the UE, a request to communicate with the first network entity based on an expiration of the timer occurring before a reception of a downlink communication from the second network entity; and transmitting, to the UE, a response to the request to communicate with the first network entity. The network entity 304/305 further includes means for receiving a second request for an RRC reestablishment procedure with the UE, the second request for the RRC reestablishment request being received based on the beam associated with the second network entity not being received at the UE. The means may be the beam indication component 150 of the network entity 304/305 configured to perform the functions recited by the means.

In another configuration, the network entity 304/305 includes means for receiving a backhaul communication from a first network entity indicative of a first transmission from the first network entity including an indication of a beam associated with the second network entity, the indication of the beam corresponding to at least one of a TCI state associated with non-dedicated signaling from the second network entity or an activation delay time for the beam based on whether the beam corresponds to dedicated signaling from the second network entity to a UE or the non-dedicated signaling from the second network entity; and means for transmitting a downlink communication using the non-dedicated signaling based on the backhaul communication received from the first network entity indicative of the first transmission from the first network entity including the indication of the beam associated with the second network entity. The network entity 304/305 further includes means for transmitting the downlink communication based on at least one of an activation delay time, the TCI state, or a QCL of an active CC, the downlink communication associated with the non-dedicated signaling from the second network entity. The means may be the beam indication component 150 of the network entity 304/305 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Optional blocks of the processes and flowcharts are indicated by dashed lines. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, communication signaling diagrams, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the invention consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “clement,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a first network entity, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to the UE or the non-dedicated signaling from the second network entity; and attempting to receive a downlink communication from the second network entity based on the indication.

Example 2 may be combined with example 1 and further includes transmitting a UE capability report indicative of a minimum delay for the activation delay time of the beam, the minimum delay being measured after reception of the indication of the beam associated with the second network entity.

Example 3 may be combined with any of examples 1-2 and includes that the minimum delay for the activation delay time of the beam is measured from a last symbol of the indication received from the first network entity.

Example 4 may be combined with any of examples 1-3 and further includes transmitting ACK/NACK feedback for the indication received from the first network entity, the minimum delay for the activation delay time of the beam being measured from a last symbol of the ACK/NACK feedback.

Example 5 may be combined with any of examples 1-4 and further includes receiving a configuration for the activation delay time of the beam associated with the second network entity based on at least one of RRC signaling, a MAC-CE, or DCI, the configuration for the activation delay time being specific to the second network entity or common to a plurality of cells that include the second network entity.

Example 6 may be combined with any of examples 1-5 and includes that the activation delay time for the beam associated with the second network entity is based on whether the indication of the beam corresponds to the TCI state associated with the non-dedicated signaling.

Example 7 may be combined with any of examples 1-6 and includes that at least one of a first CC is associated with the indication of the beam or a second CC is associated with a transmission of the ACK/NACK feedback responsive to the indication of the beam, the indication of the beam received from the first network entity indicative of the TCI state.

Example 8 may be combined with any of examples 1-7 and includes that the TCI state associated with the non-dedicated signaling from the second network entity corresponds to a joint TCI state indicative of both downlink signaling and uplink signaling, or a separate TCI state indicative of one of the downlink signaling or the uplink signaling.

Example 9 may be combined with any of examples 1-8 and includes that an activation status of at least a subset of one or more other CCs corresponding to one or more other cells than a PCell is based on a pre-configuration of the one or more other cells.

Example 10 may be combined with any of examples 1-9 and further includes refraining from monitoring at least a subset of channels in an active CC having at least one of the TCI state or a QCL associated with a different cell from the PCell of the second network entity, REs of the at least the subset of channels being indicated as available or unavailable.

Example 11 may be combined with any of examples 1-10 and further includes receiving the downlink communication from the second network entity based on the at least one of the activation delay time, the TCI state, or the QCL of the active CC, the downlink communication associated with the non-dedicated signaling from the second network entity.

Example 12 may be combined with any of examples 1-11 and further includes initiating, after the activation delay time for the beam, a first timer for reception of the downlink communication from the second network entity; and stopping the first timer and the second timer based on the reception of the downlink communication from the second network entity occurring before an expiration of the first timer.

Example 13 may be combined with any of examples 1-12 and further includes receiving the downlink communication from the second network entity before the expiration of the timer; and transmitting an ACK to the first network entity in response to the downlink communication being received from the second network entity before the expiration of the timer.

Example 14 may be combined with any of examples 1-12 and further includes transmitting, to the first network entity, a request to communicate with the first network entity based on the expiration of the timer occurring before the reception of the downlink communication from the second network entity; and receiving, from the first network entity, a response to the request to communicate with the first network entity.

Example 15 may be combined with any of examples 1-14 and includes that at least one of the ACK or the request to communicate with the first network entity is transmitted to the first network entity based on at least one of a CFRA procedure, a CBRA procedure, a PUCCH, a PUSCH, or the DCI.

Example 16 may be combined with any of examples 1-15 and further includes initiating, after the activation delay time for the beam, a second timer for a second transmission of an RRC reestablishment request, the RRC reestablishment request being transmitted based on the second timer reaching an expiration time of the second timer.

Example 17 is a method of wireless communication at a first network entity, including: transmitting, to a UE, an indication of a beam associated with a second network entity, the indication of the beam corresponding to at least one of a TCI state associated with non-dedicated signaling from the second network entity or an activation delay time for the beam based on whether the beam corresponds to dedicated signaling from the second network entity to the UE or the non-dedicated signaling from the second network entity; and receiving ACK/NACK feedback for the indication transmitted to the UE.

Example 18 may be combined with example 17 and further includes receiving a UE capability report indicative of a minimum delay for the activation delay time of the beam, the minimum delay being measured after transmission of the indication of the beam associated with the second network entity.

Example 19 may be combined with any of examples 17-18 and includes that the minimum delay for the activation delay time of the beam is measured from a last symbol of the indication transmitted to the UE.

Example 20 may be combined with any of examples 17-19 and includes that the minimum delay for the activation delay time of the beam is measured from a last symbol of the ACK/NACK feedback.

Example 21 may be combined with any of examples 17-20 and further includes transmitting a configuration for the activation delay time of the beam associated with the second network entity based on at least one of RRC signaling, a MAC-CE, or DCI, the configuration for the activation delay time being specific to the second network entity or common to a plurality of cells that include the second network entity.

Example 22 may be combined with any of examples 17-21 and includes that the activation delay time for the beam associated with the second network entity is based on whether the indication of the beam corresponds to the TCI state associated with the non-dedicated signaling.

Example 23 may be combined with any of examples 17-22 and includes that at least one of a first CC is associated with the indication of the beam or a second CC is associated with a reception of the ACK/NACK feedback responsive to the indication of the beam, the indication of the beam transmitted to the UE indicative of the TCI state.

Example 24 may be combined with any of examples 17-23 and includes that the TCI state associated with the non-dedicated signaling from the second network entity corresponds to a joint TCI state indicative of both downlink signaling and uplink signaling, or a separate TCI state indicative of one of the downlink signaling or the uplink signaling.

Example 25 may be combined with any of examples 17-24 and includes that an activation status of at least a subset of one or more other CCs corresponding to one or more other cells than the PCell is based on a pre-configuration of the one or more other cells.

Example 26 may be combined with any of examples 17-25 and further includes receiving an ACK from the UE indicative of the beam associated with the second network entity being received at the UE.

Example 27 may be combined with any of examples 17-25 and further includes receiving, from the UE, a request to communicate with the first network entity based on an expiration of the timer occurring before a reception of a downlink communication from the second network entity; and transmitting, to the UE, a response to the request to communicate with the first network entity.

Example 28 may be combined with any of examples 17-27 and includes that at least one of the ACK or the request to communicate with the first network entity is received from the UE based on at least one of a CFRA procedure, a CBRA procedure, a PUCCH, a PUSCH, or the DCI.

Example 29 may be combined with any of examples 17-28 and further includes receiving a second request for an RRC reestablishment procedure with the UE, the second request for the RRC reestablishment request being received based on the beam associated with the second network entity not being received at the UE.

Example 30 is a method of wireless communication at a second network entity, including: receiving a backhaul communication from a first network entity indicative of a first transmission from the first network entity including an indication of a beam associated with the second network entity, the indication of the beam corresponding to at least one of a TCI state associated with non-dedicated signaling from the second network entity or an activation delay time for the beam based on whether the beam corresponds to dedicated signaling from the second network entity to a UE or the non-dedicated signaling from the second network entity; and transmitting a downlink communication using the non-dedicated signaling based on the backhaul communication received from the first network entity indicative of the first transmission from the first network entity including the indication of the beam associated with the second network entity.

Example 31 may be combined with example 30 and includes that the backhaul communication received from the first network entity is based on a UE capability report indicative of a minimum delay for the activation delay time of the beam.

Example 32 may be combined with any of examples 30-31 and includes that a configuration of the activation delay time for the beam is specific to the second network entity or common to a plurality of cells that include the second network entity.

Example 33 may be combined with any of examples 30-32 and includes that the activation delay time for the beam associated with the second network entity is based on whether the indication of the beam corresponds to the TCI state associated with the non-dedicated signaling.

Example 34 may be combined with any of examples 30-33 and includes that the TCI state associated with the non-dedicated signaling from the second network entity corresponds to a joint TCI state indicative of both downlink signaling and uplink signaling, or a separate TCI state indicative of one of the downlink signaling or the uplink signaling.

Example 35 may be combined with any of examples 30-34 and further includes transmitting the downlink communication based on at least one of an activation delay time, the TCI state, or a QCL of an active CC, the downlink communication associated with the non-dedicated signaling from the second network entity.

Example 36 may be combined with any of examples 30-35 and includes that a transmission of the downlink communication is configured to trigger stopping a timer at the UE.

Example 37 may be combined with any of examples 30-36 and includes that the transmission of the downlink communication is configured to trigger ACK/NACK feedback to the first network entity.

Example 38 is an apparatus for wireless communication for implementing a method as in any of examples 1-37.

Example 39 is an apparatus for wireless communication including means for implementing a method as in any of examples 1-37.

Example 40 is a non-transitory computer-readable medium storing computer executable code, the code when executed by at least one processor causes the at least one processor to implement a method as in any of examples 1-37.

What is claimed is:

1. A method of wireless communication at a user equipment (UE), comprising:
receiving, from a first network entity, an indication of a beam associated with a transmission configuration indicator (TCI) state, the TCI state being indicative of an inter-cell mobility (ICM) procedure associated with a second network entity or a non-ICM procedure associated with the first network entity;
determining an activation delay time associated with the indication of the beam when the TCI state is indicative of the ICM procedure associated with the second network entity; and
attempting to receive a downlink communication from the second network entity based on the activation delay time for the beam when the beam is associated with the ICM procedure associated with the second network entity.

2. The method of claim 1, further comprising:
transmitting a UE capability report indicative of a minimum delay for the activation delay time of the beam associated with the second network entity, the minimum delay being measured after reception of the indication of the beam associated with the second network entity.

3. The method of claim 2, wherein the minimum delay for the activation delay time of the beam is measured from a last symbol of the indication received from the first network entity.

4. The method of claim 1, further comprising:
transmitting, to the first network entity, acknowledgment/negative acknowledgment (ACK/NACK) feedback for the indication received from the first network entity, wherein the activation delay time of the beam associated with the second network entity is measured from a last symbol of the ACK/NACK feedback.

5. The method of claim 1, further comprising:
receiving the indication of the beam associated with the TCI state indicative of the ICM procedure associated with the second network entity based on a medium access control-control element (MAC-CE).

6. The method of claim 5, wherein the MAC-CE includes a flag to indicate that the activation delay time for the beam is associated with the TCI state indicative of the ICM procedure associated with the second network entity.

7. (canceled)

8. The method of claim 1, wherein the TCI state associated with the second network entity corresponds to a joint TCI state indicative of both downlink signaling and uplink signaling, or a separate TCI state indicative of one of the downlink signaling or the uplink signaling.

9. (canceled)

10. The method of claim 1, further comprising:
refraining from monitoring at least a subset of channels in an active CC having one of the TCI state or a quasi co-location (QCL) associated with a different cell from a PCell of the second network entity, resource elements (REs) of the at least the subset of channels being indicated as available or unavailable.

11. (canceled)

12. The method of claim 1, further comprising:
initiating, after the activation delay time for the beam, a timer for reception of the downlink communication from the second network entity; and
resetting the timer based on the reception of the downlink communication from the second network entity occurring before an expiration of the timer.

13. The method of claim 12, further comprising:
receiving the downlink communication from the second network entity before the expiration of the timer; and
transmitting an acknowledgment (ACK) to the first network entity in response to the downlink communication being received from the second network entity before the expiration of the timer.

14. The method of claim 12, further comprising:
transmitting, to the first network entity, a request to communicate with the first network entity based on the expiration of the timer occurring before reception of the downlink communication from the second network entity; and
receiving, from the first network entity, a response to the request to communicate with the first network entity.

15. (canceled)

16. The method of claim 12, further comprising:
initiating a radio resource control (RRC) reestablishment procedure based on the expiration of the timer.

17. A method of wireless communication at a first network entity, comprising:
transmitting, to a user equipment (UE), an indication of a beam associated with a transmission configuration indicator (TCI) state, the TCI state being indicative of an inter-cell mobility procedure (ICM) associated with a second network entity, the TCI state enabling the UE to determine an activation delay time associated with the indication of the beam when the TCI state is indicative of the ICM procedure associated with the second network entity; and
receiving acknowledgment/negative acknowledgment (ACK/NACK) feedback for the indication transmitted to the UE, the activation delay time of the beam associated with the second network entity being measured from a last symbol of the ACK/NACK feedback.

18. The method of claim 17, wherein the TCI state corresponds to a joint TCI state indicative of both downlink signaling and uplink signaling, or a separate TCI state indicative of one of the downlink signaling or the uplink signaling.

19. The method of claim 17, further comprising transmitting a backhaul communication to the second network entity indicative of the transmitting the indication of the beam associated with the second network entity.

20-22. (canceled)

23. An apparatus for wireless communication comprising:
a memory; and
at least one processor coupled to the memory and configured to:
receive, from a first network entity, an indication of a beam associated with a transmission configuration indicator (TCI) state, the TCI state being indicative of an inter-cell mobility (ICM) procedure associated with a second network entity or a non-ICM procedure associated with the first network entity;
determine an activation delay time associated with the indication of the beam when the TCI state is indicative of the ICM procedure associated with the second network entity; and
attempt to receive a downlink communication from the second network entity based on the activation delay time for the beam when the beam is associated with the ICM procedure associated with the second network entity.

24. The apparatus of claim 23, wherein the at least one processor is further configured to:
transmit a capability report of the apparatus indicative of a minimum delay for the activation delay time of the beam associated with the second network entity, the minimum delay being measured after reception of the indication of the beam associated with the second network entity.

25. The apparatus of claim 23, wherein the at least one processor is further configured to:
transmit, to the first network entity, acknowledgement/negative acknowledgement (ACK/NACK) feedback for the indication received from the first network entity, wherein the activation delay time of the beam associated with the second network entity is measured from a last symbol of the ACK/NACK feedback.

26. The apparatus of claim 23, wherein the at least one processor is configured to receive the indication of the beam associated with the TCI state indicative of the ICM procedure associated with the second network entity based on a medium access control-control element (MAC-CE).

27. The apparatus of claim 26, wherein the MAC-CE includes a flag to indicate that the activation delay time for the beam is associated with the TCI state indicative of the ICM procedure associated with the second network entity.
